(19) United States
(12) Patent Application Publication
(10) Pub. No.: US 2021/0013552 A1
(43) Pub. Date: Jan. 14, 2021

(54) BIPOLAR AQUEOUS INTERCALATION BATTERY STACK AND ASSOCIATED SYSTEM AND METHODS

(71) Applicant: Thomas H. Madden, Glastonbury, CT (US)

(72) Inventor: Thomas H. Madden, Glastonbury, CT (US)

(21) Appl. No.: 16/768,605

(22) PCT Filed: Nov. 14, 2019
(86) PCT No.: PCT/US2019/061495

§ 371 Date: May 29, 2020

Related U.S. Application Data
(60) Provisional application No. 62/767,284, filed on Nov. 14, 2018.

(51) Int. Cl. H01M 10/38; H01M 4/58; H01M 4/505; H01M 4/525; H01M 10/04; H01M 2/16; H01M 2/30

(52) U.S. Cl. CPC H01M 10/38; H01M 4/5825; H01M 4/505; H01M 2/30; H01M 10/0468; H01M 2/1686; H01M 4/525

(57) ABSTRACT

A bipolar battery stack incorporating aqueous intercalation battery (AIB) materials is described. The bipolar AIB battery stack can include anode layers made from anode intercalation materials, The disclosed bipolar AIB stack can provide low impedance, rapid manufacturing, and low materials costs. Due to the inherently safe nature of the AIB materials, the requirements for heat removal are significantly relaxed and no requirements exist for cell bypass, Accordingly, the disclosed bipolar AIB stack configuration provides a durable and cost-effective energy storage battery for many renewable applications.

### CROSS-REFERENCE TO RELATED APPLICATION(S)

This patent application claims the benefit of and priority to U.S. Provisional Patent Application No. 62/767,284, titled BIPOLAR BATTERY STACK INCLUDING AQUEOUS INTERCALATION BATTERY MATERIALS, AND ASSOCIATED SYSTEM AND METHODS, filed Nov. 14, 2018, which is incorporated by reference herein in its entirety by reference thereto.

### TECHNICAL FIELD

The present technology relates to battery energy storage devices, and more specifically, to battery energy storage devices incorporating aqueous intercalation battery (AIB) materials in a bipolar configuration.

### BACKGROUND

Economic, widespread implementation of renewable energy using sustainable technologies, such as solar or wind, requires the safe, efficient, cost-effective, and durable storage of electrical energy. The requirements for battery technologies in these applications are very stiff. Batteries must be provided at installed costs of ˜$100/kWh and must be capable of a 20-year lifetime with daily cycling to greater 85% depth of discharge (DOD). Also, they must exhibit a general insensitivity to the ambient conditions, such as no loss of cycle life in hot climate applications. Although several battery technologies are available to perform these functions, those made at adequate manufacturing scale suffer from some key drawbacks.

By far the most widespread technology installed for these applications is lithium ion battery (LIB) technology. This class of batteries encompasses a broad set of options for anode and cathode materials to achieve different metrics, but generally there exists tradeoffs between cost, safety, energy density, and cycle life. LIB technologies that can leverage economies-of-scale for electric vehicle (EV) manufacturing are not necessarily suitable for the low cost, long-life requirements of renewable applications. Also, LIB technology fundamentally does not maintain high cycle life in high temperature applications. Furthermore, the risks of thermal runaway also require that LIBs maintain a high degree of temperature control, as well as cell-level voltage monitoring and current control. These limitations require the use of LIBs in hot climate applications to include systems with air conditioning, which increases the system complexity, cost, and operating expenses. Since many economic solar applications exist in hot weather climates, the high installed and operating costs of LIB installations limit the penetration of solar in these markets.

Sealed lead acid (SLA) battery technology is also mature with the key advantages of very low installed costs, and the ability to hold charge for long periods of time. This has resulted in SLA batteries being utilized in many backup power applications, as well as more starting, lighting, and ignition (SLI) applications. The main drawback for SLA batteries is the very limited cycle life tradeoff that exists with the battery DOD. This means that in order to continually cycle SLA batteries for thousands of cycles, the battery capacity must be substantially oversized to limit the system DOD. This negates the low installed costs. Also, the high temperature tolerance of SLA batteries is generally worse than LIBs, which also requires the installation of air conditioning in hot climate applications.

Aqueous intercalation batteries (AIB) are an emerging battery technology that involves the use of ceramic-based active materials that are capable of ion exchange functionality. Like common LIB cathodes and lithium titanate (LTO) anodes, these materials have transition metals in an inorganic crystal framework. Electrochemical modulation of these metal centers is accompanied by the reversible exchange of mobile cations in order to balance charge. Unlike LIBs however, AIB materials operate in a safer, lower cost aqueous electrolyte. But the use of aqueous electrolytes requires the use of lower voltage electrochemical couples, and generally limits the cell voltage of these systems to greater than 2.0V per cell between top-of-charge (TOC) and bottom-of-discharge (BOD). This limits the energy density of these batteries. Therefore, although the active material costs are low, fundamentally durable and temperature tolerant, the low energy density presents a barrier to a cost-effective battery. Therefore, AIBs must strive for the highest energy density configuration possible in order to meet the required cost targets.

Previous commercial embodiments of AIB technology involve the use of a mono-polar current collection scheme to build parallel capacity. By this, it is meant that layers of free-standing electrode pellets were electrically connected in parallel through the means of a stainless steel current collector bus, for both anode and cathode, in a single cell. This design has the advantage of building up an arbitrary capacity in a single cell that depends only on the cell cavity dimensions and the number of layers. However, disadvantages of this scheme include the non-uniform current collection that results in both the plane of the electrode pellet and across the bus. Also, since highly conductive stainless steel is required to minimize electronic ohmic resistance losses, a corrosion risk exists because of aqueous electrolyte contacting the steel at elevated potentials. While short-term studies of corrosion at similar conditions may suggest chemical compatibility, it is very difficult to guarantee that corrosion can be prevented over the required application lifetime. This is particularly true in the case of AIB since cathode potentials tend to increase over time. Although different stainless steels may offer improved corrosion protection, they result in higher costs. Finally, the energy density and manufacturability of this configuration is limited due to the quantity of stainless steel that is required within the parallel cell structure. Therefore, it is clear that economic and durable implementation of AIB requires a different battery design that addresses the aforementioned limitations.

### BRIEF DESCRIPTION OF THE DRAWINGS

FIG. 1 is a side schematic view of a bipolar AIB battery stack according to various embodiments described herein.

FIGS. 2A and 2B show a perspective and cross-section perspective view of a bipolar AIB battery according to various embodiments described herein.

FIG. 3 is a graph showing the charge/discharge behavior of individual cells in a 4-cell bipolar AIB batter stack configured in accordance with various embodiments described herein.

FIG. 4 is a graph showing measurements of round-trip efficiency during C/4 cycling at room temperature of two bipolar AIB battery stacks using the design shown in FIGS. 2A and 2B.

FIG. 5 a side schematic view of a traditional monopolar battery stack architecture.

FIG. 6 is a side-by-side comparison graph showing the results of theoretical calculations of battery impedance for monopolar (“P1”) versus bipolar (“P2”) designs.

### DETAILED DESCRIPTION

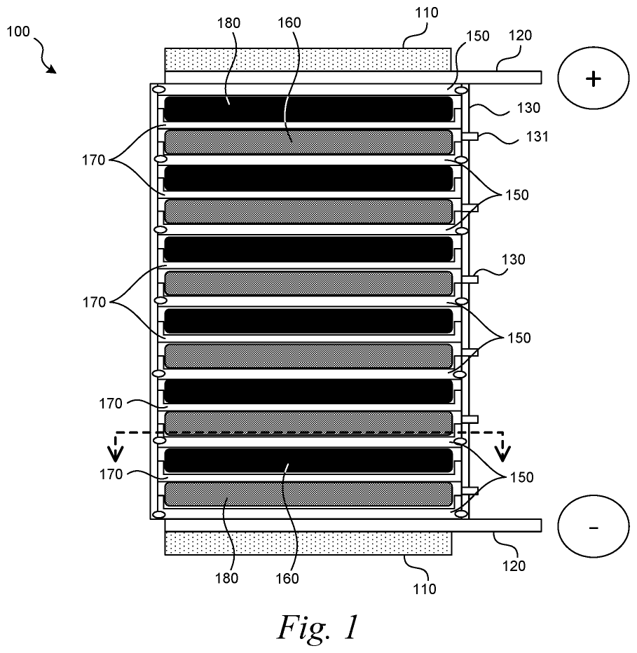

With reference to FIG. 1, a 6-cell bipolar stack 100 using aqueous intercalation battery (AIB) materials is shown. While the stack 100 includes six cells, it should be appreciated that any number of cells can be included in stack 100. The stack 100 generally includes pressure plates 110 and current collector layers 120 on either end of the stack 100. The pressure plates 110 are used to deliver a uniform load distribution. Current collector layers 120 are used to deliver or extract the current during charge and discharge, respectively. Each current collector layer 120 is juxtaposed on to a bipolar stack housing 130 on either end of the bipolar stacking housing 130. The bipolar stack housing 130 is substantially non-porous and contains the electrolyte fluid within the bipolar stack 100. A bond or seal can be used to secure the current collector layers 120 to either end of the bipolar stack housing 130. The stack 100 further includes a plurality of bipolar layers 150 on either side of each cell of the stack 100. The bottom most bipolar layer 150 connects to the anode layer 160 of the bottom most cell. Within the bottom most cell is the aforementioned anode layer 160, followed by a separator layer 170 and a cathode layer 180. This pattern repeats to form a plurality of cells within the stack 100. At the top most cell of the stack 100, the top most bipolar layer 150 connects to the top most cathode layer 180 of the top most cell. In the configuration shown in FIG. 1, the current collector layers 120 are electrically connected to the bottom most anode layer 160 and the top most cathode layer 180 (via a bipolar layer 150), respectively, but are fluidically isolated from cells.

With regard to the bipolar stack housing 130, The housing 130 can be made from low cost material, such as plastic. In some embodiments, the housing 130 is a plurality of plastic picture frames, each containing the contents of an individual cell. As these cells are stacked vertically, the plastic picture frames are bonded to one another using an adhesive, thermal or ultrasonic welding, or similar process. A similar connection can be made between the housing 130 and the bipolar layers 150. Each plastic frame may have a port 131 which facilitates electrolyte introduction into the stack during assembly, and/or venting of gases generated during normal battery operation. In some embodiments, the individual port 131 of each picture frame may be connected to a common manifold that extends through the pressure plate assembly. There may be a single manifold, or multiple manifold/port arrangements.

The bipolar layers 150 are substantially non-porous to inhibit any loss of electrolyte through liquid or vapor-phase transport. The bipolar layers 150 must be substantially non-porous to prevent ionic shunting with adjacent cells. In the design shown in FIG. 1, parallel capacity is increased simply through the electrode size, which is substantially uniform throughout any cross-sectional plane of the stack 100. Since current collection occurs uniformly through the plane of the stack 100, there is no need for highly conductive materials to facilitate in-plane conduction of electrons. Therefore, the bipolar layers 150 may be made of conductive and corrosion-resistant graphite or carbon pitch-based composites with some degree of polymer filling. The design shown in FIG. 1 therefore removes the requirement for any corrosion-prone material, like stainless steel, to be in direct contact with the electrolyte.

Several options exist for the fabrication of the bipolar layer 150. The general requirements for the bipolar layer 150 include low through-plane conductivity, very low porosity, and low cost. In some embodiments, the bipolar layer 150 is a composite material that is comprised of some form of carbon powder (generally graphite and/or carbon black) and a polymer (such as polyethylene, polypropylene, or any thermoplastic). The carbon and polymer, plus additional additives, may comprise a bulk molding compound, which is formed into a 0.5 to 2 mm thick plate of arbitrary areal dimension using extrusion, compression molding, or related process. In other embodiments, a graphite sheet material is rendered non-porous through an impregnation, co-lamination, densification, or combination thereof. In still other embodiments, the bipolar layer 150 is made from a conductive polymer, such as where ultra-high molecular weight polyethylene (UHMWPE) polymer is mixed with some form of conductive carbon and extruded into a film. For any of the above described embodiments, the thickness of the bipolar layer should be minimized to reduce cost and through-plane resistance so long as adequate mechanical properties are maintained.

The anode layer 160 includes an intercalating material, such as an intercalating ceramic, ion conducting material. In some embodiments, the intercalating material is sodium titanium phosphate (STP). In some embodiments, the intercalating material included in the anode layer 160 is a material of the general stoichiometry TiₓP_{y}O_{z}, lithium titanate (LTO), the Prussian-blue class of metal-cyano complexes, or mixtures thereof.

The separator layer 170 facilitates ionic contact with the cathode but prevents direct electrical contact. In some embodiments, the separator may comprise a woven or non-woven cotton sheet, polyvinyl chloride (PVC), polyethylene (PE), glass fiber, or any other suitable separator material.

The cathode layer 180 can include any common cathode intercalation materials for LIB, including those of the general Li-containing oxide composition of lithium manganese oxide (LMO), nickel-manganese-cobalt (NMC), nickel-cobalt-aluminum (NCA), iron-phosphate (LFP), cobalt (LCO), or combinations thereof. Also, substantially sodium conducting versions of the cathode layer may also be employed, including but not limited to the Prussian-blue class of metal-cyano complexes, sodium-manganese-titanium-phosphate (NMTPO), or sodium manganese oxide (NMO).

In one preferred embodiment described herein, the anode layer 160 is formed from sodium titanium phosphate (STP) and the cathode layer 180 is formed from lithium manganese oxide (LMO).

The electrode layers (i.e., the anode layers 160 and/or the cathode layers) are generally porous, rectangular electrode structures, which may be formed through an extrusion or pressing operation after mixing the above described intercalation materials with carbon materials and some form of polymer binder. In the final electrode layer structure, the intercalating material are interspersed within the porous electrode structure.

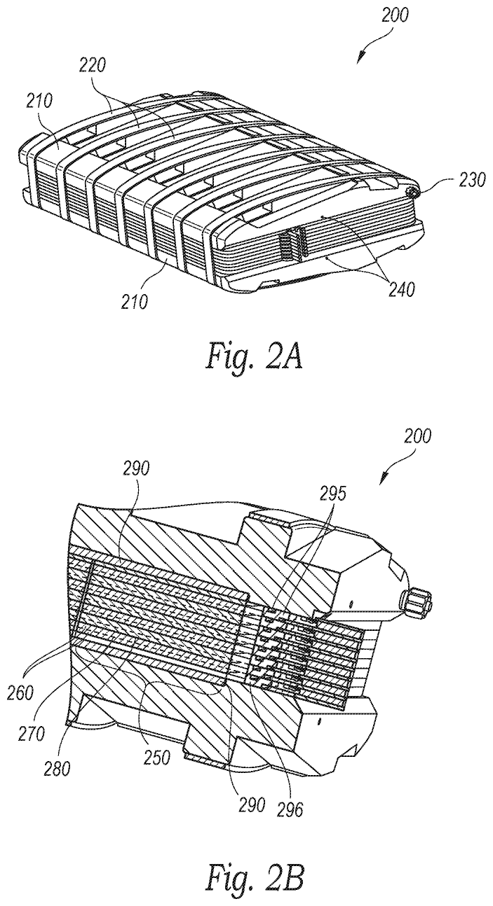

Although there exist many potential design variations for a fully assembled bipolar AIB battery, one example design is shown in FIGS. 2A and 2B. FIG. 2A shows a bipolar AIB battery 200 including eight stacks using a band-loading configuration to load the pressure plates 210. The pressure plates can be comprised of, e.g., acrylonitrile butadiene styrene (ABS), and as shown in FIG. 2A, assume a domed structure for delivering uniform loading across the active area. Material is selectively removed from the pressure plate 210 to accommodate the band tensioning and crimping tools. Band loading straps 220 are provided for each cell and surround the pressure plates 210 to apply the desired pressure on the stacks positioned between the pressure plates 210. An electrolyte fill and gas management system (not shown) can connected to the stack externally through a Luer-lock fitting 230. In the design shown in FIG. 2A, there are two separate manifolds that communicate with each cell through the end assembly to facilitate effective filling and gas management. Battery leads 240 also connect through the end assemblies to the terminal mono-polar layers through a conductive sheet made of stainless steel or copper. This design can optionally include standard connectors for measuring individual cell voltages, which is important in the development of system configurations.

FIG. 2B shows a cross-sectional view of the AIB battery 200 shown in FIG. 2A. As described previously with respect to FIG. 1, each stack 250 in the AIB battery 200 includes multiple cells (in this case, eight cells per stack), with electrodes 260 being separated by separator layers 270, and cells being separated by bipolar layers 280. At opposite ends of the stack 250 are elastomer sheets 290, which are designed to perform a degree of load follow-up to offset any compression set of the cell components. Each individual cell within the stack 250 is contained within a dedicated frame, which is stacked as shown to build to a desired voltage. In this design shown in FIG. 2B, sealing to external is achieved through O-ring seals 295, which are held within glands 296 and enclose the periphery of the cells. Since the bipolar layer 280 runs between the plastic frames, two O-rings are required for each surface. Also shown is one method for the connection of standard connectors to the bipolar layers.

Several options exist for sealing the cells in the bipolar stack in addition to the O-ring scheme shown in FIGS. 2A and 2B. The first involves the use of a selective compliance assembly robot arm (SCARA) to dispense a continuous adhesive over the frames to effect permanent bonding. Another involves dispensing a cure-in-place seal material, which can optionally use the existing O-ring glands to receive and contain this material. Still another involves modifications to the bipolar layer, either with an adhesive layer over all or some of either/both of its surfaces, or to formulate the bipolar layer with enough elastomeric properties to itself perform the sealing function. Another option is to permanently seal the plastic frames using thermal or ultrasonic welding as the stack is built up. There may be combinations of the above sealing approaches, where one method is used for the repeat cell seals, and the other method is used for sealing the end assemblies to the first and last cells.

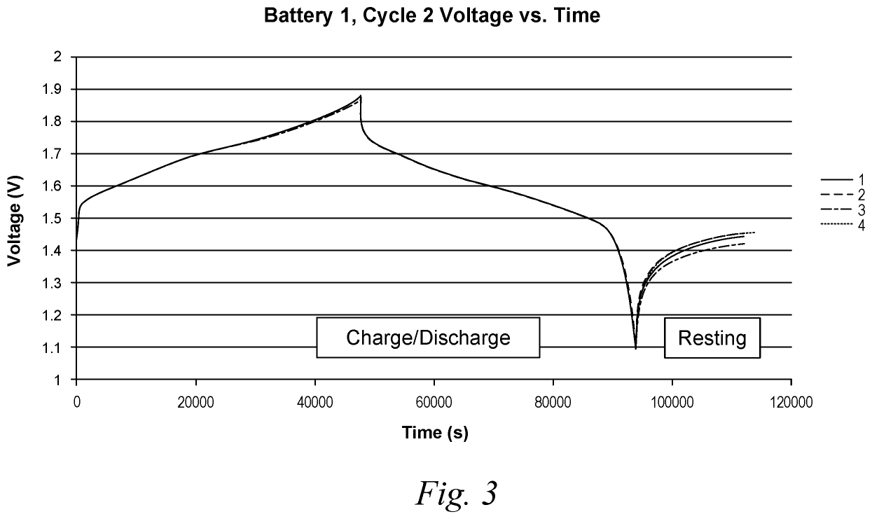

FIG. 3 plots the individual cell voltages versus time, showing the charge and discharge characteristics for a 4-cell AIB bipolar stack of a similar design to that shown in FIGS. 2A and 2B. This design includes the individual voltage monitoring connectors. The uniformity of the cells is manifest in the near equivalence of the cell voltages across charge and discharge, with only slight differences in open circuit voltage seen during the rest period. During this time, diffusional relaxation occurs, both within the active material particles with the intercalating ion concentration and with the ion concentrations within the adjacent electrolyte. Maintaining cell-to-cell uniformity is a critical metric, as any voltage criterion used to limit charge and/or discharge will depend on the most extreme value, and growth in this value over time will ultimately limit the capacity. Hence the minimum-maximum cell voltage difference at all points in the charge-discharge, including and especially during rest periods, must be monitored continuously during long-term cycling to assess durability.

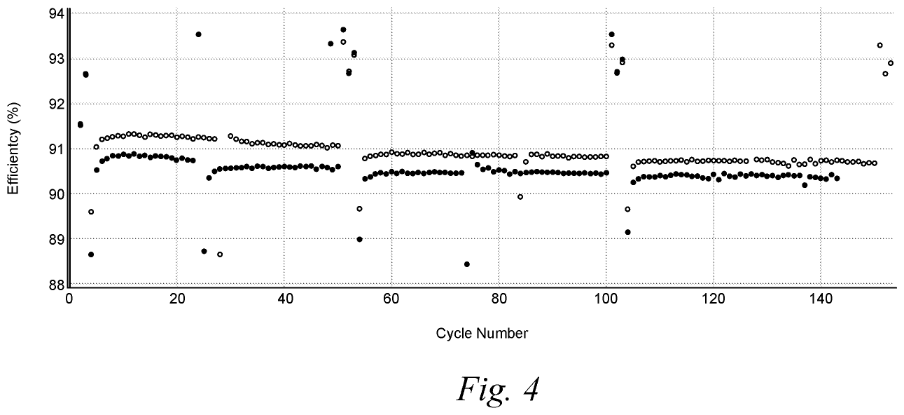

FIG. 4 plots the round-trip efficiency versus cycle number for the early phases of long-term cycling of AIB bipolar battery prototypes similar in design to that depicted in FIGS. 2A and 2B. Some initial stabilization period occurs where some loss of efficiency is experienced, which is expected to be related to contact resistance as these prototypes lacked any provision for load follow-up. As predicted by the theoretical calculations, the improved impedance of these stacks allows for stable cycling greater than 90% round-trip efficiency. Both long cycle life and consistent, high round-trip efficiency are key in battery storage projects to improve the long-term economics and justify the initial investment.

It should be understood that many variations exist for the design and assembly of a bipolar AIB battery, and the examples shown in FIGS. 2A and 2B are intended to depict examples only. It is not the intention of this disclosure to limit the possible variations in design of a bipolar stack. Rather, it is to articulate the inherent advantages of implementing AIB materials into a bipolar stack that is the key invention intended by this disclosure.

### Benefits/Advantages

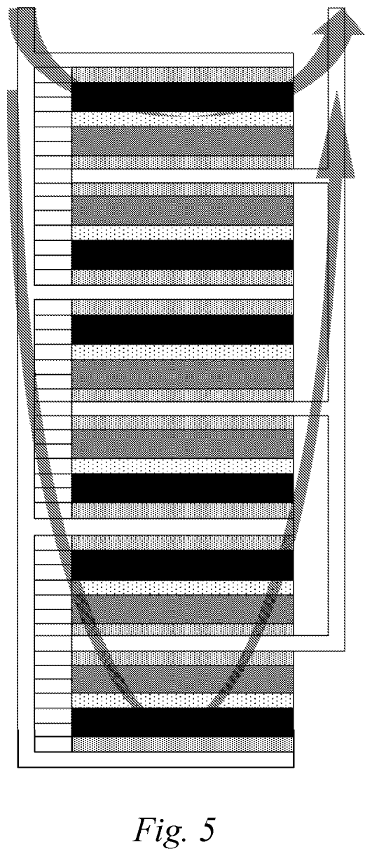

Traditionally, AIB batteries have been assembled using a mono-polar battery architecture. FIG. 5 depicts parallel layers in a mono-polar stack design. Due to the non-uniform length of the current flow, different layers have different degrees of ohmic resistance. Therefore, the current flow to each layer will not be uniform. This can lead to different layers achieving different states-of-charge during charging and discharging of the battery stack. Also, the overall impedance of this type of stack is inherently high, owing to the many layers with non-uniform current lengths, as well as associated contact resistances.

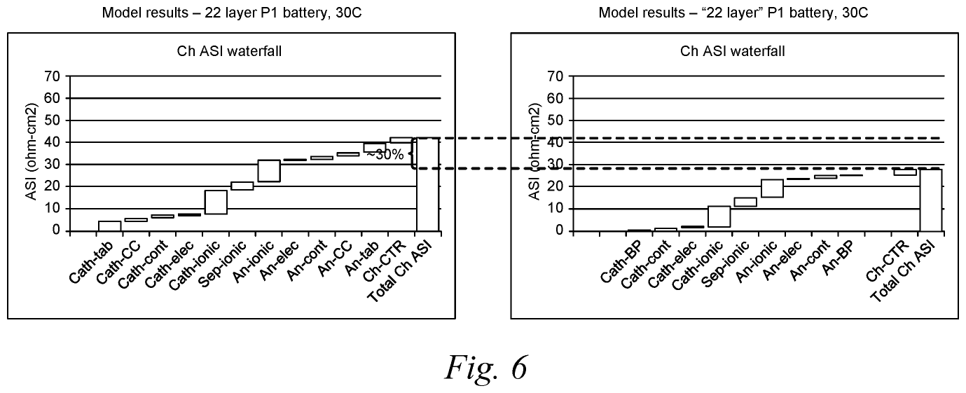

In contrast, bipolar stacks have more uniform current distributions and overall lower impedance. This is illustrated in FIG. 6, where a physics-based model was used to estimate the overall battery impedances for a mono-polar battery design (“P1”) versus a bipolar battery design (“P2”). The model results for the P1 design match impedance measurements made of a battery with this architecture. The model results show that a bipolar design is expected to reduce the overall battery impedance by ˜30%. Lower impedance leads to higher battery capacities due to a higher degree of active material utilization, and higher round-trip efficiencies. This degree of impedance reduction is predicted to facilitate stable cycling at C/4 rates of charge/discharge at greater than 90% round-trip efficiency. Another advantage over mono-polar designs is that the bipolar layers, which conduct electrons from the cathode of one cell to the anode of the next cell do not require high in-plane electrical conductivity. This is in contrast to the mono-polar designs, which do require high in-plane electrical conductivity to move electrons efficiently across the face of the electrodes. This requirement leads to these current collectors being comprised, at least partially, of some sort of metal. Since this metal is in contact with the electrodes and battery electrolyte during operation, corrosion of the metal current collector is a serious concern. In contrast, the bipolar design only requires high through-plane conductivity. This requirement can be achieved using carbon materials or carbon-polymer composites, which will not exhibit significant effects of corrosion.

The general advantages of a bipolar battery design include low impedance, rapid manufacturing, and low materials costs. Therefore, a bipolar stack configuration is the preferred means of realizing a durable and cost-effective energy storage battery for many renewable applications.

Despite these advantages, there are several reasons why bipolar battery designs are not more prevalent in the battery industry. There are three main reasons for this: a) difficult heat removal, b) tendency to concentrate current in the event of dendrite formation, and c) inability to disconnect individual cells in the event of thermal runaway. For plating batteries, such as lead acid or lithium ion, these concerns make their implementation in bipolar designs difficult. The lack of readily available methods for heat removal mean that these batteries may transition into a thermal runaway situation. Related to this is the possibility of dendrite formation in plating batteries. If dendrites start to form, the local impedance in that areal region will reduce and more current will tend to flow there. This will further accelerate dendrite formation, leading to a self-accelerating cell failure if/when the dendrite penetrates the separator and leads to thermal runaway. Also, unlike mono-polar designs, bipolar designs do not afford any readily available means to bypass any cell that exhibits such a failure.

However, bipolar batteries incorporating AIB materials as described herein do not have these concerns. The lack of readily available heat removal is not a major concern, since the electrode materials are comprised of ceramic-like materials that are incapable of combustion. This concern is further alleviated due to the aqueous electrolyte, which is non-flammable and has high heat capacity. Also, should any small degree of current concentration take place, the local state-of-charge of that region will increase. As the state-of-charge gets higher, this local region will necessarily exhibit higher impedance, thus diverting current from that region. Hence, AIB materials have a natural balancing mechanism which is in direct contrast to the dendrite formation of a plating battery. Therefore, for these reasons, there is no requirement to remove individual cells from the battery circuit.

### Examples

From the foregoing, it will be appreciated that specific embodiments of the invention have been described herein for purposes of illustration, but that various modifications may be made without deviating from the scope of the invention. Accordingly, the invention is not limited except as by the appended claims.

1-12. (canceled)

13. A bipolar aqueous intercalation battery (AIB) stack having a first terminal end and a second terminal end opposite the first terminal end, the bipolar AIB battery stack comprising:
two or more cells, each cell comprising:
an anode layer comprising an anode intercalation material;
a cathode layer; and
a separator layer disposed between the anode layer and the cathode layer;
wherein the anode layer, the cathode layer, and the separator layer are identically arranged in each cell such that an anode layer is at the first terminal end of the stack and a cathode layer is at the second terminal end of the stack;
a bipolar layer disposed between each cell and at the first terminal end and the second terminal end such that each individual cell is sandwiched between two bipolar layers; and
a current collector layer disposed at the first terminal end and the second terminal end such that the all cells in the stack are sandwiched between the current collector layers.

14. The bipolar AIB stack of claim 13, wherein the anode intercalation material is an intercalating ceramic, ion conducting material.

15. The bipolar AIB stack of claim 13, wherein the anode intercalation material is sodium titanium phosphate.

16. The bipolar AIB stack of claim 13, wherein the anode intercalation material is selected from the group consisting of lithium titanate, the Prussian-blue class of metal-cyano complexes, a compound having the general stoichiometry TiₓP_{y}O_{z} and combinations thereof.

17. The bipolar AIB stack of claim 13, wherein the cathode layer comprises a cathode intercalation material.

18. The bipolar AIB stack of claim 17, wherein the cathode intercalation material is lithium manganese oxide.

19. The bipolar AIB stack of claim 17, wherein the cathode intercalation material is selected from the group consisting of the Li-containing oxide of nickel-manganese-cobalt,
the Li-containing oxide of nickel-cobalt-aluminum, the Li-containing oxide of iron-phosphate, the Li-containing oxide of cobalt, and combinations thereof.

20. The bipolar AIB stack of claim 17, wherein the cathode intercalation material is selected from the group consisting of the Prussian-blue class of metal-cyano complexes, sodium-manganese-titanium-phosphate, sodium manganese oxide, and combinations thereof.

21. The bipolar AIB stack of claim 13, wherein the bipolar layer is a composite material comprising carbon powder and a polymer.

22. The bipolar AIB stack of claim 13, wherein the bipolar layer comprises ultra-high molecular weight polyethylene (UHMWPE) polymer and a conductive carbon.

23. The bipolar AIB stack of claim 13 further comprising a pressure plate disposed at the first terminal end and the second terminal end such that all cells and the current collector layers are sandwiched between the pressure plates.

24. The bipolar AIB stack of claim 13 further comprising a housing extending around the periphery of the cells.

25. The bipolar AIB stack of claim 24, wherein the housing comprises a plurality of picture frame housings, the periphery of each cell being surround by an individual picture frame housing

26. The bipolar AIB stack of claim 24, wherein the edges of the bipolar layers are secured to the housing via a weld or an adhesive,

27. The bipolar AIB stack of claim 24 wherein the housing includes one or more ports configured for introducing electrolyte into the bipolar AIB stack, removing gas from within the bipolar AIB stack, or both.
